(19) United States
(12) Patent Application Publication
(10) Pub. No.: US 2007/0296648 A1
(43) Pub. Date: Dec. 27, 2007

(54) Plasma display device and driving method thereof

(76) Inventor: Byung-Gwon Cho, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/724,759

(22) Filed: Mar. 15, 2007

(30) Foreign Application Priority Data
Jun. 22, 2006 (KR) 10-2006-0056469

(51) Int. Cl. G09G 3/28

(52) U.S. Cl. 345/60

(57) ABSTRACT

A plasma display device and a driving method therefor are provided. The driving method includes gradually decreasing a voltage of a first electrode during a reset period, biasing a voltage of a second electrode to a first voltage during a first period of the falling period, and biasing the second electrode to a second voltage lower than the first voltage during a second period of the falling period. The first voltage is higher than a voltage that is applied to the second electrode during an address period. Therefore, as a voltage of the second electrode is biased to a predetermined voltage in a falling period of a reset period, wall charges of the scan electrode Y and the sustain electrode X can be fully erased.

### CROSS-REFERENCE TO RELATED APPLICATION

This application claims priority to and the benefit of Korean Patent Application No. 10-2006-0056469 filed in the Korean Intellectual Property Office on Jun. 22, 2006, the entire content of which is incorporated herein by reference.

### BACKGROUND

1. Field of the Invention

The present invention relates to a plasma display device and a driving method thereof.

2. Description of the Related Technology

A plasma display device is a flat panel display for displaying characters or images using plasma that is generated by a gas discharge, and in a display panel thereof, from several tens to millions of discharge cells (hereinafter referred to as “cells”) according to a size thereof are arranged in a matrix format.

In general, in the plasma display device, one frame is divided into a plurality of subfields, each having a weight value, and a grayscale is realized by performing a time-divisional control of the subfields. Each subfield includes a reset period, an address period, and a sustain period. The reset period is a period of initializing a state of each cell so as to smoothly perform an address operation in a cell, and the address period is a period of selecting a cell to emit light among a plurality of cells through an address discharge. Further, a sustain period is a period of performing a sustain discharge in a cell to emit light.

In the reset period, in a state where a reference voltage (e.g., 0V) is applied to a sustain electrode and an address electrode, a voltage of a scan electrode is gradually increased, and in a state where a predetermined voltage is applied to the sustain electrode, a voltage of the scan electrode is gradually decreased. During the reset period, wall charges for stably performing an address discharge are formed in each electrode.

However, in the reset period, if wall charges of the scan electrode and the sustain electrode are erased to be suitable for an address operation, wall charges that are formed in the address electrode as well as the scan electrode and the sustain electrode are also erased. In this way, if a wall voltage between the scan electrode and the address electrode becomes low as wall charges in the address electrode are erased, a smooth address operation cannot be performed in the address period.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

Various embodiments provide a plasma display device and a driving method thereof having advantages of performing a stable address operation in an address period. Further, various embodiments provide a plasma display device and a driving method thereof having advantages of performing a stable operation in an address period and a sustain period.

One aspect is a driving method for a plasma display device including a first electrode and a second electrode, and a third electrode intersecting the first electrode and the second electrode. The method includes gradually decreasing a voltage of the first electrode from a first voltage to a second voltage during a falling period of a reset period, biasing the second electrode to a third voltage during a first period of the falling period, where the third voltage is higher than the second voltage, biasing the second electrode to a fourth voltage during a second period of the falling period, where the fourth voltage is lower than the third voltage, and applying a fifth voltage to the second electrode during an address period, where the fifth voltage is lower than the third voltage.

Another aspect is a plasma display device including a plasma display panel (PDP) that includes a first electrode and a second electrode and a third electrode intersecting the first electrode and the second electrode. The device includes a driver configured to drive the PDP, and a controller configured to divide one frame into a plurality of subfields to control the driver, where the driver is further configured to gradually decrease a voltage of the first electrode during a falling period of a reset period of at least one subfield, bias the second electrode to a first voltage during a first period of the falling period, bias the second electrode to a second voltage during the remaining period of the falling period, where the second voltage is lower than the first voltage, and apply a third voltage to the second electrode during an address period where the first voltage is higher than the third voltage.

Another aspect is a plasma display device including a plasma display panel (PDP) that includes a first electrode and a second electrode and a third electrode intersecting the first electrode and the second electrode. The device includes a driver configured to gradually decrease a voltage of the first electrode during a falling period of a reset period, bias the second electrode to a first voltage during a first period of the falling period and to a second voltage during a second period of the falling period, where wall charges of the first and second electrodes are substantially erased.

### BRIEF DESCRIPTION OF THE DRAWINGS

FIG. 1 is a view illustrating a plasma display device according to an embodiment.

FIG. 2 is a diagram illustrating a driving waveform of a plasma display device according to an embodiment.

FIG. 3 is a diagram illustrating a driving waveform of a plasma display device according to another embodiment.

FIG. 4 is a diagram illustrating a driving waveform of a plasma display device according to another embodiment.

### DETAILED DESCRIPTION OF CERTAIN INVENTIVE EMBODIMENTS

In the following detailed description, only certain embodiments of the present invention have been shown and described, simply by way of illustration. As those skilled in the art would realize, the described embodiments may be modified in various ways, without departing from the spirit or scope of the present invention. In the drawings, parts irrelative to the description are omitted, and like reference numerals generally designate like elements throughout the specification.

Wall charges are charges formed and accumulated on a wall (e.g., a dielectric layer) close to an electrode of a discharge cell. Although the wall charges do not actually touch the electrodes, the wall charges will be described as being “formed” or “accumulated” on or in the electrode, and “wall voltage” means a potential difference between the wall and ground that is formed in the wall of the cell by the wall charges. Further, when it is said that any portion “includes” some constituent element, it means that the portion may further include a different constituent element unless otherwise described, without excluding other constituent elements.

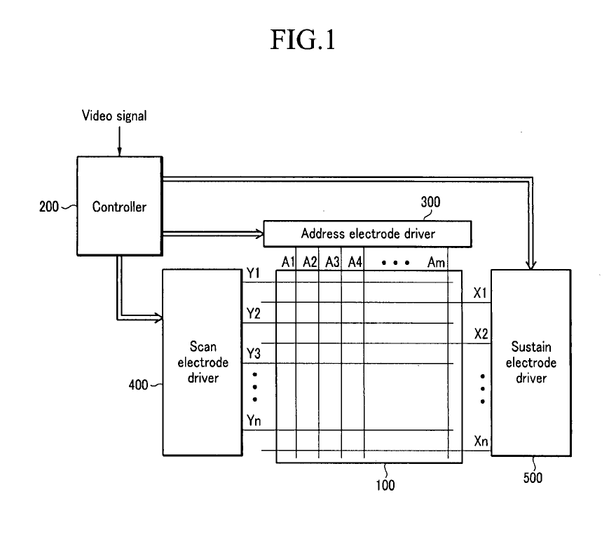

A plasma display device according to an embodiment is described in detail with reference to FIG. 1.

FIG. 1 is a view illustrating a plasma display device according to an embodiment.

As shown in FIG. 1, the plasma display device includes a PDP 100, a controller 200, an address electrode driver 300, a scan electrode driver 400, and a sustain electrode driver 500.

The PDP 100 includes a plurality of address electrodes A1-Am that extend in a column direction, and a plurality of sustain electrodes X1-Xn and a plurality of scan electrodes Y1-Yn that extend in a row direction. The plurality of scan electrodes Y1-Yn and sustain electrodes X1-Xn are formed and arranged in pairs. Discharge cells are formed near adjacent scan electrodes and sustain electrodes where an address electrode intersects the scan and sustain electrodes. A structure of the PDP 100 is an example, and a panel of other structures that can apply a driving waveform to be described later can also be applied to the present invention.

The controller 200 receives an external video signal, and outputs an address electrode driving control signal, a sustain electrode driving control signal, and a scan electrode driving control signal. In the controller 200, one frame is driven by dividing the frame into a plurality of subfields, and each subfield includes a reset period, an address period, and a sustain period according to a sequential operation change.

The address electrode driver 300 receives the address electrode driving control signal from the controller 200 to apply a display data signal for selecting a discharge cell to display, to each address electrode.

The scan electrode driver 400 receives the scan electrode driving control signal from the controller 200 to apply a driving voltage to the scan electrode.

The sustain electrode driver 500 receives the sustain electrode driving control signal from the controller 200 to apply a driving voltage to the sustain electrode.

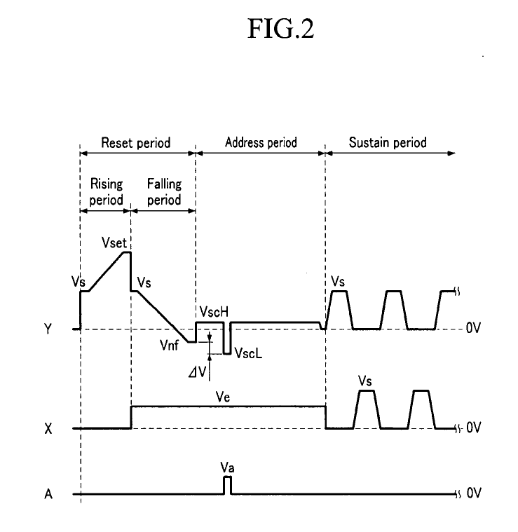

Next, a driving waveform of a plasma display device according to one embodiment is described in detail with reference to FIGS. 2 to 4. Hereinafter, for better understanding and ease of description, only a driving waveform that is applied to a scan electrode Y, a sustain electrode X, and an address electrode A of one cell will be described.

FIG. 2 is a diagram illustrating a driving waveform of a plasma display device according to one embodiment.

As shown in FIG. 2, each subfield of the plasma display device includes a reset period, an address period, and a sustain period. Further, the reset period includes a rising period and a falling period.

During the rising period of the reset period, when the sustain electrode X sustains a reference voltage (0V in FIG. 2), a voltage of the scan electrode Y gradually increases from a voltage Vs to a voltage Vset. While a voltage of the scan electrode Y increases, as a minimal discharge (hereinafter referred to as a “weak discharge”) is generated between the scan electrode Y and the sustain electrode X and between the scan electrode Y and the address electrode A, negative (−) wall charges are formed in the scan electrode Y and positive (+) wall charges are formed in the sustain electrode X and the address electrode A. When a voltage of the scan electrode Y gradually increases, wall charges are formed so that the sum of a voltage that is applied from the outside and a wall voltage of a cell may sustain a discharge firing voltage Vf while a weak discharge is generated in the cell. Further, a voltage Vset is sufficiently high voltage to generate a discharge in cells of all conditions, since cells of any condition are initialized in a reset period.

Next, in a falling period of a reset period, when a voltage of the sustain electrode X sustains a voltage Ve, a voltage of the scan electrode Y gradually decreases from a voltage Vs to a voltage Vnf. While a voltage of the scan electrode Y decreases, a weak discharge is generated between the scan electrode Y and the sustain electrode X and between the scan electrode Y and the address electrode A. During a rising period, negative (−) wall charges that have been formed in the scan electrode Y and positive (+) wall charges that have been formed in the sustain electrode X and the address electrode A are erased. As a result, negative (−) wall charges of the scan electrode Y decrease and positive (+) wall charges of the sustain electrode X and the address electrode A decrease. In FIG. 2, in a reset period, a voltage of the scan electrode Y increases or decreases in a ramp pattern, but another form of waveform gradually increasing or decreasing may be applied.

During an address period, when a voltage Ve is applied to the sustain electrode X to select a discharge cell to emit light, a scan pulse having a voltage VscL is sequentially applied to a plurality of scan electrodes Y. An address pulse having a voltage Va is applied to the address electrode A that passes through a discharge cell to emit light among a plurality of discharge cells that are formed by the scan electrode Y and the sustain electrode X to which a voltage VscL is applied. Then, as an address discharge is generated between an address electrode A to which a voltage Va is applied and a scan electrode Y to which a voltage VscL is applied, and between the scan electrode Y to which the voltage VscL is applied and a sustain electrode X to which a voltage Ve is applied, positive (+) wall charges are formed in the scan electrode Y and negative (−) wall charges are formed in each of the address electrode A and the sustain electrode X. At this time, a voltage VscH (a non-scan voltage) higher than the voltage VscL is applied to the scan electrode Y to which the voltage VscL is not applied, and a reference voltage is applied to the address electrode A of any unselected discharge cells.

In the sustain period, sustain discharge signals alternately having a high level voltage (a voltage Vs in FIG. 2) and a low level voltage (0V in FIG. 2) are applied to the scan electrode Y and to the sustain electrode X with substantially opposite phases. That is, when the voltage Vs is applied to the scan electrode Y, a voltage 0V is applied to the sustain electrode X, and when the voltage Vs is applied to the sustain electrode X, a voltage 0V is applied to the scan electrode Y. A discharge is generated in the scan electrode Y and the sustain electrode X in response to the difference between a wall voltage and a voltage Vs that are formed at the scan electrode Y and the sustain electrode X, respectively, by an address discharge. Thereafter, a sustain discharge pulse is repeatedly applied to the scan electrode Y and the sustain electrode X a number of times corresponding to a weight value with which the corresponding subfield displays.

In order to perform a smooth address operation during the address period, as shown in FIG. 2, a difference ΔV between a final voltage Vnf to which a voltage of the scan electrode Y gradually decreases during the falling period of the reset period and the voltage Vscl of the scan pulse that is applied to the scan electrode Y during the address period increases. Accordingly, address discharge characteristics are improved and the voltage of the address pulse that is applied to the address electrode A can be lowered.

However, as shown in FIG. 2, in a process of increasing the ΔV, when wall charges are erased less in the address electrode A by increasing a difference between a voltage Vscl and a voltage Vnf based on the voltage Vscl, wall charges that have been formed in the scanning electrode (Y) and the sustain electrode (X) in a falling period of a reset period are not fully erased. When wall charges that have been formed in the scan electrode Y and the sustain electrode X are not fully erased in the falling period of the reset period, misfiring is generated during the sustain period. Specifically, during a sustain period, a sustain discharge is generated by a difference between a wall voltage that has been formed between the scan electrode Y and the sustain electrode X and a voltage of the applied sustain discharge pulse. However, during a reset period, when a sustain discharge pulse is applied to the scan electrode Y and the sustain electrode X when wall charges of the scan electrode Y and the sustain electrode X were not fully erased, a discharge can be generated in cells meant to not emit light. Hereinafter, a driving method of a plasma display device that can prevent misfiring even if the ΔV increases will be described.

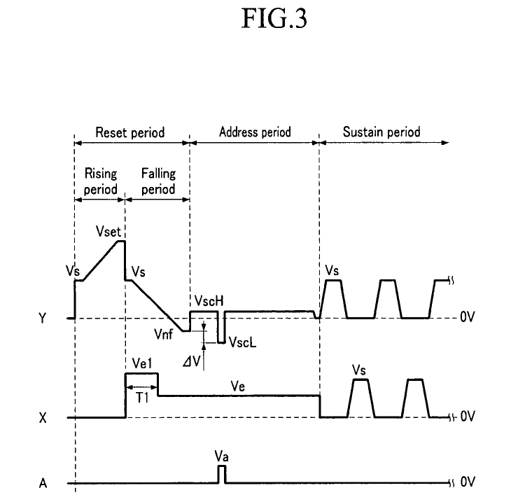

FIG. 3 is a diagram illustrating a driving waveform of a plasma display device according to another embodiment. In FIG. 3, during a falling period of the reset period, except for biasing the sustain electrode (X) to a predetermined voltage, the remaining driving waveform and method are similar to those of FIG. 2 and thus descriptions thereof will be omitted.

In FIG. 3, unlike the case of FIG. 2, during the falling period of the reset period, during a period T1, the sustain electrode X is biased to a voltage Ve1, a voltage of the scan electrode Y gradually decreases from a voltage Vs toward a voltage Vnf. A voltage of the address electrode A sustains a reference voltage (0V in FIG. 3). Further, a voltage Vnf is higher than a voltage Vscl, and a difference ΔV between a voltage Vscl and a voltage Vnf is large. In this way, in a state where the sustain electrode X is biased to a voltage Ve1, if the ΔV increases based on a voltage Vscl, a voltage difference between the scan electrode Y and the sustain electrode X becomes larger than that when the sustain electrode X is biased to a voltage Ve, thereby erasing more wall charges. Accordingly, as the voltage of the address electrode A is a reference voltage, wall charges are erased less than when wall charges are erased without the ΔV increase.

Specifically, during a falling period of the reset period, during the period T1, if a voltage of the sustain electrode X is biased to a voltage Ve1, a voltage difference between the scan electrode Y and the sustain electrode X becomes larger than that when a voltage of the sustain electrode X sustains a voltage Ve. Accordingly, wall charges that have been formed in the scan electrode Y and the sustain electrode X are erased more. Further, as a voltage of the address electrode A is a reference voltage, wall charges that have been formed in the address electrode A are erased less than when wall charges are erased without the ΔV increase. Accordingly, during the address period, as a scan pulse and an address pulse are applied to the scan electrode Y and the address electrode A, respectively, a smooth address operation can be performed. Further, in order to reduce the number of voltage sources for a voltage Ve1, the voltage Ve1 may be set to be equal to the voltage Vs.

However, when a period T1 is too long or when a voltage of a sustain electrode X is biased to a voltage Ve1 over an entire falling period of a reset period, wall charges are excessively erased between the scan electrode and the sustain electrode and thus a low discharge may be generated. Accordingly, the period T1 is adjusted so that wall charges between the scan electrode Y and the sustain electrode X may be erased to be suitable for an address operation.

Hereinafter, in order to erase wall charges of the scan electrode Y and the sustain electrode X to be suitable for an address operation, another embodiment of biasing the sustain electrode X to a predetermined voltage in a falling period of a reset period will be described.

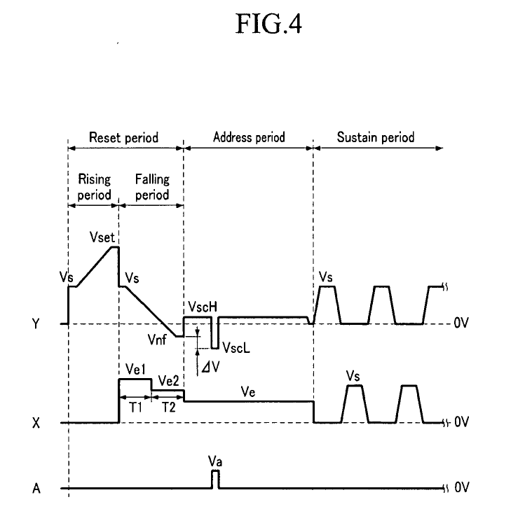

FIG. 4 is a diagram illustrating a driving waveform of a plasma display device according to another embodiment.

As shown in FIG. 4, in this embodiment, during a falling period of a reset period, during a period T1, after being biased to a voltage Ve1, a voltage of the sustain electrode X is then biased to a voltage Ve2 during a period T2. During the falling period of the reset period, the voltage of the scan electrode Y gradually decreases from a voltage Vs to a voltage Vnf. Further, the voltage of the address electrode A sustains a reference voltage (0V in FIG. 4).

In this way, during the period T1, if the voltage of the sustain electrode X is biased to a voltage Ve1, wall charges that have been in the scan electrode Y and the sustain electrode X are erased more than when the voltage of the sustain electrode X sustains a voltage Ve. That is, the difference between the scan electrode Y voltage and the sustain electrode X voltage when the voltage of the sustain electrode X is biased to a voltage Ve1, is greater than when the sustain electrode X is biased to a voltage Ve. Further, during a period T2, as the voltage of the sustain electrode X is biased to a voltage Ve2 lower than a voltage Ve1, wall charges of the scan electrode Y and the sustain electrode X are prevented from being excessively erased which could happen if the voltage of the sustain electrode X is continuously biased to Ve1.

In this way, during a falling period of a reset period, as the voltage of the sustain electrode X is biased to a voltage, wall charges of the scan electrode Y and the sustain electrode X are erased to be suitable for an address operation and a sustain discharge even if the ΔV increases. Further, because wall charges of the address electrode A are erased less than when the ΔV is small, an effective address operation can be performed in an address period.

According to one embodiment, as a voltage of the sustain electrode is biased to a voltage during a falling period of the reset period, wall charges of the scan electrode and the sustain electrode can be properly erased even if the ΔV increases. Further, as the ΔV increases, an effective address operation can be performed and the voltage of the address pulse that is applied to the address electrode can be lowered in a circuit.

While embodiments have been described in connection with what is presently considered to be practical implementations, it is to be understood that the invention is not limited to the disclosed embodiments, but, on the contrary, is intended to cover various modifications and equivalent arrangements.

What is claimed is:

1. A driving method for a plasma display device comprising a first electrode and a second electrode, and a third electrode intersecting the first electrode and the second electrode, the method comprising:
gradually decreasing a voltage of the first electrode from a first voltage to a second voltage during a falling period of a reset period;
biasing the second electrode to a third voltage during a first period of the falling period, wherein the third voltage is higher than the second voltage;
biasing the second electrode to a fourth voltage during a second period of the falling period, wherein the fourth voltage is lower than the third voltage; and
applying a fifth voltage to the second electrode during an address period, wherein the fifth voltage is lower than the third voltage.

2. The driving method of claim 1, wherein the second period is continuous with the first period.

3. The driving method of claim 2, wherein the second voltage is higher than a voltage of a scan pulse to be applied to the first electrode during the address period.

4. The driving method of claim 3, wherein the third voltage is higher than a voltage that is applied to the third electrode during the falling period.

5. The driving method of claim 4, wherein the fourth voltage is substantially equal to the fifth voltage.

6. The driving method of claim 5, wherein the third voltage is substantially equal to a high level voltage of a sustain discharge pulse that is applied to the second electrode during a sustain period.

7. A plasma display device comprising a plasma display panel (PDP) that comprises a first electrode and a second electrode and a third electrode intersecting the first electrode and the second electrode, the device comprising:
a driver configured to drive the PDP, and
a controller configured to divide one frame into a plurality of subfields to control the driver,
wherein the driver is further configured to:
gradually decrease a voltage of the first electrode during a falling period of a reset period of at least one subfield;
bias the second electrode to a first voltage during a first period of the falling period;
bias the second electrode to a second voltage during the remaining period of the falling period, wherein the second voltage is lower than the first voltage; and
apply a third voltage to the second electrode during an address period wherein the first voltage is higher than the third voltage.

8. The plasma display device of claim 7, wherein the first period is at an initial part of the falling period.

9. The plasma display device of claim 8, wherein the driver is configured to gradually decrease the voltage of the first electrode during the falling period to a voltage higher than a voltage of a scan pulse to be applied to the first electrode during the address period.

10. The plasma display device of claim 9, wherein the first voltage is higher than a voltage that is applied to the third electrode during the first period.

11. The plasma display device of claim 10, wherein the second voltage is substantially equal to a voltage that is applied to the second electrode during the address period.

12. The plasma display device of claim 11, wherein the first voltage is substantially equal to a high level voltage of a sustain discharge pulse that is applied to the second electrode during a sustain period.

13. The plasma display device of claim 7, wherein the second voltage is substantially equal to the third voltage.

14. The plasma display device of claim 7, wherein he driver is further configured to apply a fourth voltage to the third electrode during the falling period, and the first voltage is higher than the fourth voltage.
